(19) United States
(12) Patent Application Publication
(10) Pub. No.: US 2013/0062927 A1
(43) Pub. Date: Mar. 14, 2013

(54) BICYCLE WHEEL RIM HAVING SIDEWARDLY OPENING TWO-PART SLIT SHAPED SPOKE MOUNTING APERTURES

(71) Applicant: Richard McAinsh, Villa D'adda (IT)

(72) Inventor: Richard McAinsh, Villa D'adda (IT)

(73) Assignee: 3T DESIGN LIMITED, Hong Kong (CN)

(21) Appl. No.: 13/520,826

(22) PCT Filed: Dec. 10, 2010
(86) PCT No.: PCT/EP10/69410

§ 371 Date: Sep. 24, 2012

(30) Foreign Application Priority Data
Jan. 21, 2010 (NL) 2004125

(51) Int. Cl. B60B 1/04; B60B 5/02; B60B 21/06

(52) U.S. Cl. 301/58

(57) ABSTRACT

A bicycle wheel rim 1 includes a wall with two opposite radially outwardly extending annular sidewall parts 2a, b in which a plurality of slit shaped spoke mounting apertures are provided. Spokes 10 are provided which include a shaft 11 with a thickened head 12. Each slit extends both in a sideward and radial outward direction and includes a first slit part 15 and a second slit part 16, where the first slit part has cross sectional dimensions lying between the cross sectional dimensions of the shaft and the head, and the second slit part has cross sectional dimensions larger than the cross sectional dimensions of the head. The second slit part lies further radially outward than the first slit part, and the slit parts are both open in the direction of the central axis of the rim and in the direction of at least one of the sidewall parts of the rim.

### CROSS-REFERENCE TO RELATED APPLICATIONS

This application is the National Stage of International Application No. PCT/EP2010/069410, filed Dec. 10, 2010, which claims the benefit of Netherlands Application No. 2004125, filed Jan. 21, 2010, the contents of which is incorporated by reference herein.

### FIELD OF THE INVENTION

The invention relates to a bicycle wheel rim construction, and in particular to the shape of spoke mounting apertures provided therein.

### BACKGROUND OF THE INVENTION

Conventional bicycle wheels comprise an annular wheel rim, a central hub and a number of spokes connecting them with each other. The spokes are usually thin metal rounded wire spokes with a thread on one end and a J-shaped hook with a head on the other end. In the most common configurations, the spokes have first been inserted in openings in flanges of the hub until their hook with thickened head abuts against the hub flange. Threaded nipples are installed in corresponding holes in the rim. The nipples are connected with the threaded spoke ends and the spokes are subsequently tensioned by rotation of the nipples.

A disadvantage with this conventional wheel, in particular if it has a deep carbon rim profile, is that, being the lower side of the nipple larger than the spoke, the hole in the rim has to be larger than the diameter of the spoke. This weakens the structural strength of the rim. Also the nipple holes in the rim lead to high concentrated stresses applied to the surrounding rim walls and the weight of the nipples at the rim increase the angular inertia of the wheel and its resistance to acceleration. Further, the spokes frequently tend to break at the location of their J-shaped hook.

It has been tried to solve these problems by reversing the spokes and at the same time making them fully straight. For example U.S. Pat. No. 5,810,453 shows an embodiment in which the spokes have been inserted through central openings in the annular bottom rim wall, against which they are abutting with a thickened head while their spoke shafts hang freely downwardly. Nipples here are seated in flange openings of the hub. The openings in the rim can now be manufactured smaller and the straight spokes break less easily.

Nevertheless, some problems connected to manufacturing and/or load transfer still remain with this reversed spoke construction. For example, it is necessary to remove the wheel tire when one of the spokes needs to be replaced. Also, the rim construction needs internal strengthening walls diverging towards the central openings in the bottom wall of the rim. This increases the weight of the rim.

US 2003/0209936 shows a wheel rim construction in which the rim is provided with rectangular transverse apertures through which thickened complementary rectangular spoke heads can be inserted. Subsequently each spoke can be rotated 90 degrees so as to fix the rectangular head part between upstanding groove walls which are provided inside an annular hollow chamber of the wheel rim. With this construction the tyre no longer needs to be removed when one of the spokes needs to be replaced.

A disadvantage with this is that the rim construction is difficult to manufacture, in particular because of the provision of its annular hollow chamber and annular groove walls upstanding therein. Furthermore, the rectangular transverse apertures are weakening the rim, and the rim still has a relative high angular inertia.

FR 2 526 374 shows a bicycle wheel rim having a radially inwardly projecting spoke mounting flange. This rim mounting flange is provided with keyhole-shaped openings. Each keyhole-shaped opening comprises a large upper keyhole part and a more slender lower keyhole part. Thus a J-shaped spoke with a thickened head on its hooked outer end can be inserted sideways into the large upper keyhole part and then be pulled radially downwards into the more slender lower keyhole part. In this position the thickened head of the spoke gets trapped by being delimited by wall parts of the flange surrounding the more slender lower keyhole part.

A disadvantage with this known construction is that the two keyhole parts are only open in the sideways direction. In the radial inward direction, that is to say towards the central axis of the rim, the keyhole parts are closed. This makes it necessary to use spokes with hooked end parts.

IT-VR-20020034 shows a bicycle wheel rim comprising an outer annular profile which defines an annular seat for a tyre. The rim further comprises an outer annular chamber and an inner annular chamber. The bottom and side walls of the inner annular chamber together define a plurality of insertion openings each for receiving a nipple for fastening a threaded end of a spoke to the rim. Each opening comprises a large upper opening part in one of the side walls and a more slender lower opening part in the bottom wall of the chamber. The nipple can be inserted sideways into the rim with a thick head part passing the large upper opening part and a slender shaft part passing the more slender lower opening part. Subsequently the nipple can be pulled downwards until the thick head part abuts against the bottom wall of the rim.

A disadvantage with this known rim construction is that it is difficult and expensive to manufacture as a one-piece integral object.

### SUMMARY OF THE INVENTION

The present invention aims to overcome one or more of the above-mentioned disadvantages, or to at least provide a usable alternative. In particular, the inventions aims to provide a user-friendly bicycle wheel rim with optimal performance behaviour because it combines a lightweight construction with a high strength.

This aim is achieved by a bicycle wheel rim according to the present invention. The rim comprises a wall with two opposite radially outwardly extending annular sidewall parts. In the rim wall a plurality of spoke mounting apertures are provided. A plurality of spokes is provided which comprise a slender shaft with a widened head. The head is provided at one of the outer ends of the shaft and has a larger cross section than the shaft. The spoke mounting apertures are delimited by wall parts of the rim, which wall parts form seats for the heads of the spokes to abut against when mounted in the spoke mounting apertures with their spoke shafts extending radially inwardly. At least one of the spoke mounting apertures is formed by a slit that extends both in a transverse sideward and radial outward direction. The slit comprises a slender first slit part and a widened second slit part. The first slit part has cross sectional dimensions lying between the cross sectional dimensions of the spoke shaft and the spoke head, in particular slightly larger than the shaft, such that the shaft can freely be placed into and removed from this first slit part whereas the head is blocked by it. The second slit part has cross sectional dimensions larger than the cross sectional dimensions of the spoke head, in particular slightly larger than the head, such that the head can be placed into and removed from this second slit part. The second slit part lies further radially outward than the first slit part. The slit parts are both open in the direction of the central axis of the rim and in the direction of at least one of the sidewall parts of the rim. This makes it possible to insert the spoke into the slit coming from the side of the respective sidewall part, and to then simply slide the spoke with its head towards its abutting mounting position. The rim construction with its sidewardly approachable two-part slits according to the invention makes the assembly of a bicycle wheel using such a rim much more user-friendly. The manufacturing complexity of the rim has become easier, particularly if it is made of carbon, and it is possible to use less material for the rim while maintaining enough strength.

It is possible for the heads of the spokes to be formed by nipples screwed onto the shafts. Preferably however the heads of the spokes have been made integral with the shafts. This has the advantage that the integral heads may have a lighter weight then the nipples which helps in reducing the angular inertia of the wheel. In an embodiment the heads have been made rotation symmetric such that it makes no difference in whatever rotational position they are to be slid into their respective slits.

Also it is possible for the spokes to still have a hooked end part, either at the location of their connections with the hub either at the location of their heads. Preferably however straight spokes are used. Neither the connection with the rim neither the connection with the hub needs a hooked end part. This makes the spokes stronger and/or makes it possible to construct them more lightweight.

The side wall parts of the rim may be directly connected to each other from where they diverge radially outwards in order to delimit a V-shaped annular space. It is also possible that a bottom wall is provided which connects the side wall parts which each other in order to together delimit a U-shaped annular space.

According to the invention the rim wall at the location of the slit parts is provided with strengthening wall parts, which extend into the internal annular space of the rim. With this there will be an increasing stiffness, the loads will be better shared on the rim walls, and the rim will be no more be subjected to high concentrated stresses.

In a further embodiment the strengthening wall parts, which delimit the slit parts towards the internal annular space, form a closed pocket in the rim wall. No holes have to be drilled into the rim wall for being able to provide the two-part slits. They can be formed as indents in the rim wall. The strengthening wall parts, which delimit the slit parts towards the internal annular space can advantageously be manufactured integral with the rest of the rim wall. Particularly if the rim is made out of a moulded composite material, in particular a carbon fibre reinforced material, this strongly reduces the manufacturing complexity and the strength of the rim. All in all the two-part slit pockets and the sliding positioning of the spoke heads coming from the sideward direction in these pockets helps in keeping the angular inertia of the wheel rather low and thus to give it a low resistance to acceleration. The abutting seats of the spokes in the rim pockets aid in ensuring a better load transfer between the spoke head and the rim.

Further advantageous embodiments are described herein.

The invention also relates to a bicycle wheel and a bicycle making use of the advantageous wheel rim of the present invention.

### BRIEF DESCRIPTION OF THE DRAWINGS

The invention shall be dealt with in further detail below with reference to the accompanying drawings, wherein:

FIG. 1 is a perspective partial view of a bicycle wheel embodiment according to the invention;

FIG. 2 shows a side view of FIG. 1;

FIG. 3 shows detail B of FIG. 2 in an enlarged view;

FIG. 4 shows the rim of FIG. 1 without spokes connected thereto;

FIG. 5 shows a partial side view of FIG. 4; and

FIG. 6 shows the cross section V-V of FIG. 5.

### DETAILED DESCRIPTION OF THE INVENTION:

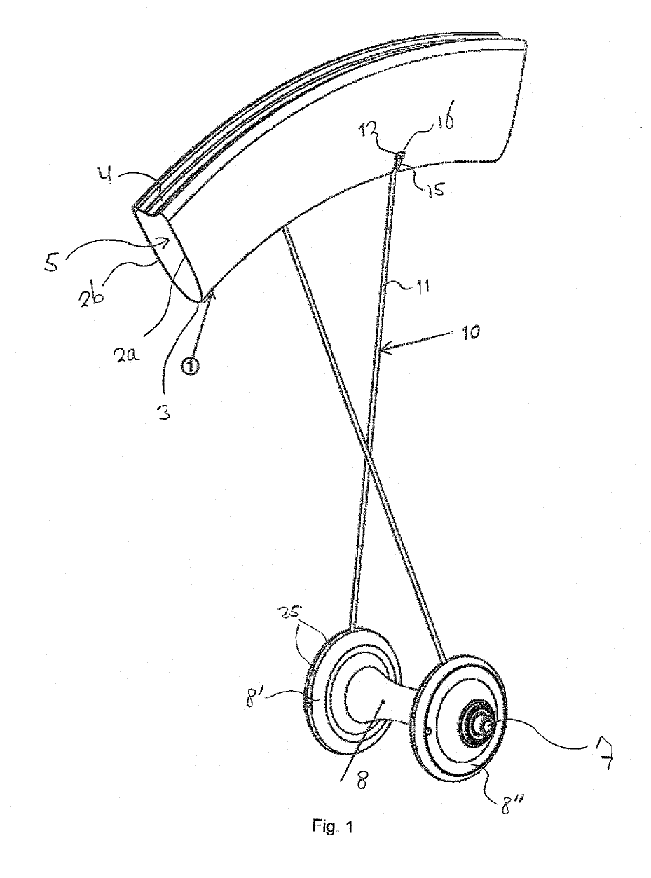

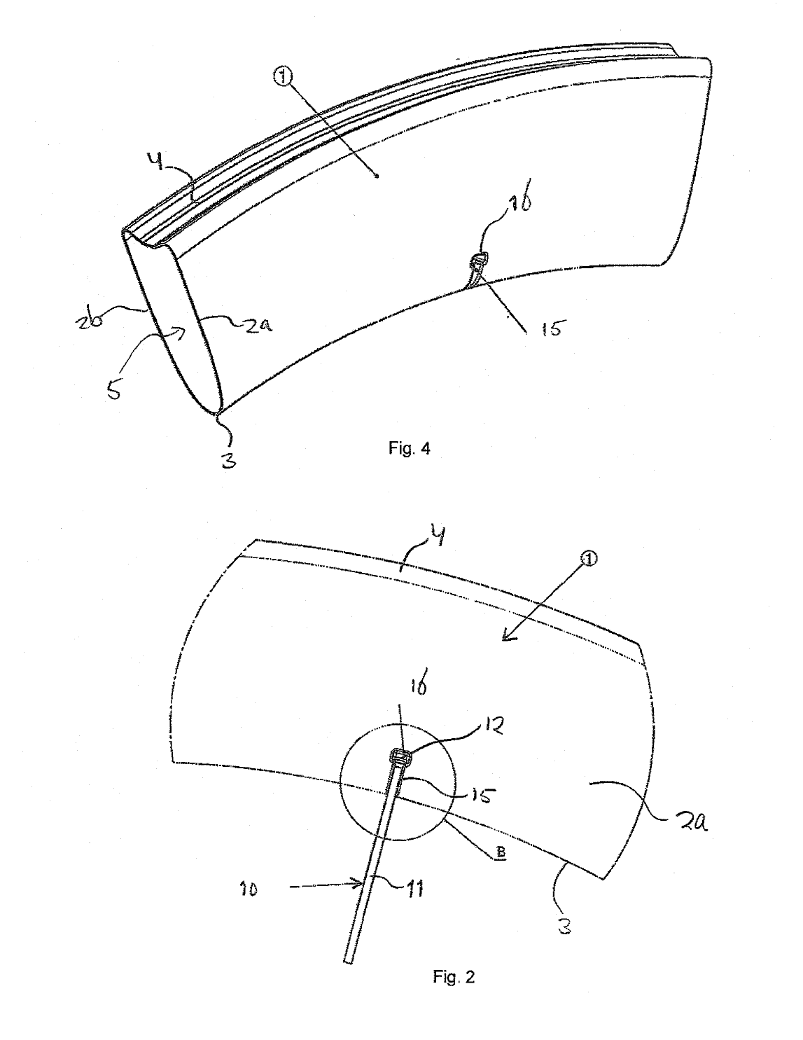

In FIG. 1-6 the annular wheel rim has been indicated with the reference numeral 1. Only a small circle segment of the rim 1 has been shown. The rim 1 here comprises two opposite radially outwardly extending annular sidewall parts 2a, 2b, a radial inward bottom wall part 3 and a radial outward tyre support wall part 4. The wall parts 2, 3, 4, seen in cross section, form a circumferentially closed wall inside which an internal hollow space 5 is present. Like the rim 1 and the wall parts 2, 3, 4 itself, the internal hollow space 5 runs like an annulus around a central axis of rotation 7.

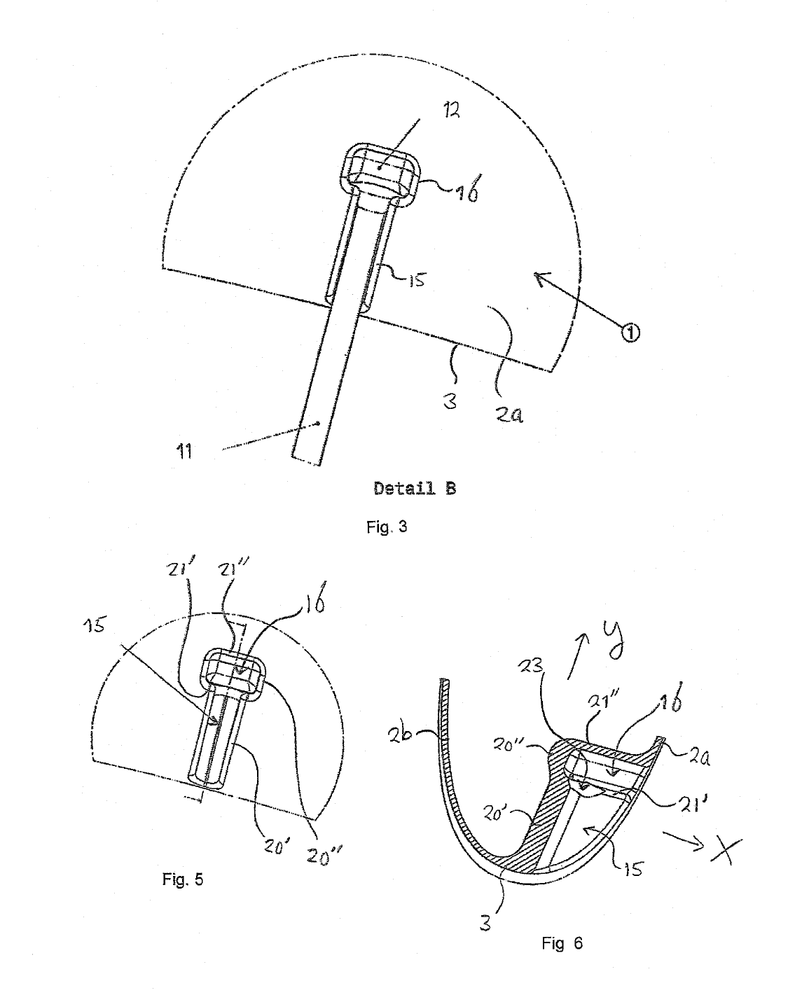

The rim 1 is connected to a central hub 8 by means of a plurality of spokes 10 of which only two are shown. Each spoke 10 comprises a longitudinal shaft 11 with an integral head 12 at its radial outward end (see FIG. 3). The head 12 has a larger cross section than the shaft 11. In particular the head 12 has a width/thickness (cross sectional dimension) which is at least one and a half times larger than the width/thickness (cross sectional dimension) of the shaft 11.

In the rim wall, and in particular in the side wall parts 2a, 2b thereof, a plurality of slit shaped spoke mounting apertures are provided. The apertures are equally divided around the circumference of the rim 1. Adjacent spoke mounting apertures are provided alternating in the two side wall parts 2a, 2b and thus open towards opposite sideward directions. As can be seen in FIGS. 5 and 6, each slit extends both in a transverse sideward direction X and in a radial outward direction Y. Furthermore each slit comprises a first slit part 15 and a second slit part 16. The first slit part 15 starts near the centre of the bottom wall part 3 and from there runs sideward and outward in the directions X and Y. The second slit part 16 extends above the entire radial outward side of the first slit part 15. The first slit part 15 is open in the directions −Y towards the central axis of rotation 7 and +X towards the sidewall part 2a in which it is provided. The second slit part 16 is open in the direction −Y towards the first slit part 15 below it and +X towards the sidewall part 2a in which it is provided. The first slit part 15 has cross sectional dimensions slightly larger than the shaft 11 and substantially smaller than the head 12. The second slit part 16 has cross sectional dimensions slightly larger than the head 12. In side view, the two slit parts 15, 16 delimit a T-shape which is substantially complementary to the upper part of the spoke 10.

The slit parts 15, 16 of each slit are delimited by so-called standing strengthening wall parts 20′, 20″ extending in the radial direction Y and so-called lying strengthening wall parts 21′, 21″ extending in the sideward direction X. Together these standing and lying strengthening wall parts 20, 21 form a closed pocket around the slit which pocket extends inwardly into the internal annular space 5 of the rim 1. The strengthening wall parts 20, 21 are manufactured integral with the rest of the rim wall. The lying strengthening wall parts 21′ extending between the transition of the first and second slit part 15, 16 form a seat 23 for the head 12 of the spoke 10 to abut against while the spoke shaft 11 extends through the first slit part 15 in the direction of the central axis 7. The closed pockets have the large advantage that the rim wall can maintain continuous even at the location of the spoke mounting apertures. The drilling of holes in the rim wall is not necessary for making the slits.

During assembly each spoke 10 may simply be pushed with its head 12 and upper shaft part 11 into one of the two-part slits, until they reach their seated end position in there. The spokes 10 are then connected with their free ends with the hub 8 and brought to a desired tension. For this the free spoke ends are provided with screw threaded end parts. The hub 8 may be provided with nipple openings 25 in opposite flanges 8′, 8″ of the hub 8, into which openings 25 threaded nipples are placed. In the alternative it is also possible to first connect the spokes 10 with the hub 8, to then push the spoke heads 12 sidewards into the slits 15, 16, and to then tension the spokes 10. Advantageously in both of the two assembly methods, the spokes 10 do not have to be bend or otherwise deformed to be able to connect them with the rim 1 and hub 8. Also the spokes 10 can advantageously be made fully straight with one common longitudinal axis.

Besides the embodiment shown numerous variants are possible. For example the rim and the slit shaped apertures therein may be given other shapes and dimensions. It is also possible to provide the hub directly with threaded holes into which spoke ends can be screwed or to connect the spokes with hooked and/or thickened end parts with the hub. The head of the spoke may even be formed by a nipple. This makes it possible to use the rim according to the invention in combination with all kinds of hubs and with or without ‘reversed’ spokes. The rim can be made out of various kinds of materials, for example metal. Preferably, however the rim is made out of a moulded composite material, in particular a carbon fibre reinforced material. The construction with the closed pockets makes the rim very suitable to be made out of such a moulded composite material. The slit parts shown extend in a sideward direction substantially perpendicular to the sidewall parts. In the alternative it is also possible to have them extend under an oblique angle to these sidewall parts.

Thus a bicycle wheel rim is provided which aids in making a bicycle lightweight, strong and fast during accelerations. In particular during racing where the demands are high, this may make a critical positive difference.

1. A bicycle wheel rim having a central axis of rotation, comprising:
a wall with two opposite radially outwardly extending annular sidewall parts;
a plurality of spoke mounting apertures in the wall;
a plurality of spokes destined for connecting the rim with a central hub;
wherein the spokes comprise a shaft with a head at its radially outward end, which head has a larger cross section than the shaft;
wherein the wall parts of the rim that are delimiting the spoke mounting apertures form seats for the heads of the spokes to abut against while the spoke shafts extend through the apertures in the direction of said central axis;
wherein at least one of the spoke mounting apertures is formed by a slit,
wherein said slit extends both in a sideward and radial outward direction and comprises a first slit part and a second slit part, wherein the first slit part has cross sectional dimensions lying between the cross sectional dimensions of the shaft and the head, and the second slit part has cross sectional dimensions larger than the cross sectional dimensions of the head;
wherein the second slit part lies further radially outward than the first slit part, and wherein the slit parts are both open in the direction of the central axis of the rim and in the direction of at least one of the sidewall parts of the rim; and
wherein said wall parts of the rim wall are provided with strengthening wall parts, which delimit the slit parts towards an internal annular space of the rim.

2. (canceled)

3. The bicycle wheel rim according to claim 1, wherein the strengthening wall parts, which delimit the slit parts towards the internal annular space, form a closed pocket in the rim wall.

4. The bicycle wheel rim according to claim 1, wherein the strengthening wall parts, which delimit the slit parts towards the internal annular space are manufactured integral with the rim wall.

5. The bicycle wheel rim according to claim 1, wherein the strengthening wall parts, which delimit the slit parts comprise standing strengthening wall parts extending in the radial direction and lying strengthening wall parts extending in the sideward direction.

6. The bicycle wheel rim according to claim 1, wherein the second slit part fully extends in the sideward direction and has wall parts delimiting its radial inward side forming the seat for the head of the spoke to abut against while the spoke shaft extends through the first slit part in the direction of said central axis.

7. The bicycle wheel rim according to claim 1, wherein the slit being open in the direction of at least one of the sidewall parts of the rim, is open in a sideward direction perpendicular to the sidewall parts.

8. The bicycle wheel rim according to claim 1, wherein adjacent spoke mounting apertures have their slits open towards opposite sideward directions.

9. The bicycle wheel rim according to claim 1, wherein the rim is made out of a moulded composite material, in particular a carbon fibre reinforced material.

10. A bicycle wheel comprising:
a central hub having flanges with a plurality of spoke mounting openings therein;
a bicycle wheel rim according to one of the preceding claims having its spokes connecting the hub and the rim with each other; and
a plurality of nipples for providing adjustment of tension in the spokes.

11. A bicycle comprising at least one bicycle wheel rim according to claim 1.
